(19) United States
(12) Patent Application Publication
(10) Pub. No.: US 2012/0258614 A1
(43) Pub. Date: Oct. 11, 2012

(54) EXPLOSION-PROTECTED PLUG-IN CONNECTOR

(75) Inventors: Martin MERTZ, Dortmund (DE); Georg Karl KANTY, Kamen (DE); Bodo BEHNISCH, Essen (DE)

(73) Assignee: FHF FUNKE + HUSTER FERNSIG GMBH, Muelheim an der Ruhr (DE)

(21) Appl. No.: 13/425,905

(22) Filed: Mar. 21, 2012

(30) Foreign Application Priority Data
Apr. 8, 2011 (DE) 20 2011 000 836.3

(51) Int. Cl. H01R 12/53; H01R 4/24

(52) U.S. Cl. 439/78; 439/391

(57) ABSTRACT

An explosion-protected plug-in connector, particularly for coupling of a VoIP telephone with a network, has at least one housing and at least one first electrical connector unit in the housing. At least one conductor end section of the network engages into the connector unit. Supplemental to the first electrical connector unit, which is configured as an IDC terminal unit, there is at least one further second IDC terminal unit provided in the housing. The conductor end section engages into the two IDC terminal units. A hold-down disposed between the two IDC terminal units is provided for the conductor end section.

### CROSS REFERENCE TO RELATED APPLICATIONS

Applicants claim priority under 35 U.S.C. §119 of German Application No. 20 2011 000 836.3 filed Apr. 8, 2011, the disclosure of which is incorporated by reference.

### BACKGROUND OF THE INVENTION

1. Field of the Invention

The invention relates to an explosion-protected plug-in connector, particularly for coupling of a VoIP telephone with a network. The connector has least one housing, and at least one first electrical connector unit in the housing. At least one conductor end section of the network engages into the electrical connector unit.

2. The Prior Art

U.S. Pat. No. 4,741,031 describes an explosion-protected telephone that is coupled with a network by way of an electrical connector unit. In this connection, a special interface is implemented.

Explosion-protected plug-in connectors or explosion-protected devices in general have great mechanical safety and avoid the formation of sparks. For this reason, there are specially designed devices for areas at risk of explosion, and all the peripheral devices must meet the requirements described above.

Only as an example, reference is made here to the “Guideline 94/9/EG of the European Parliament and of the Council dated March 23, 1994, for coordination of the legal provisions of the member states for devices and protective systems for use as intended in areas at risk of explosion.” There, areas at risk of explosion are defined, among other things, as areas in which the atmosphere can become explosive as the result of local and operating conditions. In particular, the components and devices must be designed so that ignition of explosive atmospheres is prevented in an individual case, taking electrical and non-electrical types of ignition sources into consideration. Furthermore, the materials used for the construction of the devices and protective systems must not bring about triggering of an explosion, taking operationally foreseeable stresses into consideration. Supplemental to these general provisions of law, it should be pointed out that such plug-in connectors typically must demonstrate “increased safety,” as specified in greater detail in the DIN EN 60079-7 respective IEC60079-7 standard, among others. In any case, there are numerous such requirements that make the explosion-protected plug-in connectors able to fulfill the purpose of use outlined.

In practice, there is an increasing demand for connecting telephones, but also sensors or other electrical devices, to an existing network, for example a computer network, the Internet, etc., in areas that are at risk of explosion. This is of particular importance against the background of remote monitoring and/or linking of the devices in question. Here, in practice, the work has generally been done with electrical connector units until now, which units connect the individual leads of a network cable or its conductor end section with a circuit board, for example, and the conductor tracks present there, by means of screw terminals, spring terminals, etc.

Such a method of procedure is complicated in terms of assembly technology and might be problematic due to safety aspects, under some circumstances, because a lead break can occur in connection with screw terminals and improper attachment, for example. Unintentional loosening processes in the case of spring terminals and the accompanying spark formation also cannot be entirely precluded. This is where the invention wishes to provide a remedy, as a whole.

### SUMMARY OF THE INVENTION

It is therefore an object of the invention to further develop an explosion-protected plug-in connector having the embodiment described initially, in such a manner that assembly is simplified and all safety-relevant aspects are observed.

This object is accomplished according to the invention by an explosion-protected plug-in connector that has a first electrical connector unit, which is configured as an IDC terminal unit, and at least one second IDC terminal unit provided in the housing. The conductor end section engages into the two IDC terminal units, and a hold-down disposed between the two IDC terminal units is provided for the conductor end section.

Within the scope of the invention, a specially designed explosion-protected plug-in connector is therefore used. This falls back on two IDC terminal units that are contacted with the conductor end section of the network. In this connection, the IDC terminal units are designed to be redundant. This means that in the case of failure of the one IDC terminal unit, contacting of a circuit board, an electrical device, a VoIP telephone, etc. with the network takes place by way of the other IDC terminal unit. As a result, spark formation is prevented, even in the case of a damaged electrical connection between the conductor end section and the one IDC terminal unit. This is because the electrical connection to the other IDC terminal unit continues to exist. As a result, the explosion-protected plug-in connector according to the invention is predestined for use in areas at risk of explosion.

Supplementally, the circumstance that the two IDC terminal units are accommodated jointly in the housing, and consequently are protected from external access, contributes to this. The housing as such can be configured to be open on a face side. For reasons of simple production, it has proven itself if the housing is produced in one piece from a sheet-metal part. This sheet-metal part can be a combined punched/bent metal part.

The two IDC terminal units are disposed essentially parallel to one another. The electrical connection of the conductor end section with the two IDC terminal units as a whole is brought about in such a manner that the conductor end section engages into the first and then into the second IDC terminal unit, one after the other. This means that one and the same conductor or one and the same lead of the multi-lead conductor end section engages into at least two IDC terminals, one after the other. In this connection, the one IDC terminal belongs to the first IDC terminal unit, and the further IDC terminal belongs to the second IDC terminal unit. The two IDC terminal units are consequently—so to speak—switched one behind the other with regard to the lead, and are at a distance from one another.

In this connection, contacting between the insulated lead of the multi-lead network cable, or the conductor end section and the related IDC terminal, takes place as usual, in such a manner that the lead submerges into the IDC terminal or is pressed into it, and in this connection the IDC terminal cuts through the insulation mantle of the conductor or of the lead with its fork-shaped cutting ends.

In order to support this contacting process, it has proven itself if each IDC terminal unit is equipped with an IDC terminal plug part and an assembly plug part. For electrical contacting, each lead of the conductor end section is laid into the related IDC terminals of the IDC terminal plug part and pressed into the IDC terminals of the IDC terminal plug part using the installation plug part. The fork-shaped cutting ends of the individual IDC terminals cut through the insulation of the related leads, as described, so that the desired electrical contact between the conductor end section and the electrical device to be connected with the network is produced directly and rapidly, specifically normally without using tools.

The assembly plug part is advantageously configured on the housing. In this connection, it has proven itself to affix the assembly plug part on the roof of the housing. In this way, assembly is configured to be particularly simple. This is because all that is necessary is to lay the individual leads of the conductor end section into the IDC terminals of the IDC terminal plug part. Subsequent to this, the roof of the housing is closed and connected with a floor of the housing. In this manner, the housing is closed and, at the same time, the desired electrical connection of the lead with the respective IDC terminal is accomplished.

This is because the connection of the roof of the housing with the related floor, in the case of the leads that are laid into the IDC terminal plug parts, causes the leads to be pressed into the related IDC terminals using the assembly plug part affixed to the roof of the housing. During this process, the fork-shaped cutting ends of the IDC terminals cut through the insulation of the leads, so that the desired electrical contact exists.

It is advantageous if the housing is structured in sigma shape in cross-section. The floor has a U-shaped character. The roof is normally configured in L shape. Because the housing is advantageously designed in one piece, the roof can easily be connected with the floor. For this purpose, the floor has a stop that produces the necessary connection with the roof. For this purpose, at least two attachment means are provided in order to make a mechanically double-sure connection between roof and floor available.

As has already been explained, the two IDC terminal units are advantageously connected with one and the same common circuit board. In order to design the circuit board with the electrical/electronic components situated on it so as to be explosion-protected, it is preferable if the circuit board is enclosed by a casting mass. Then the design is made in such a manner that the two IDC terminal units are the only items that emerge out of the casting mass in question, which encloses the circuit board. As an alternative to the casting mass, however, it is also possible to work with a circuit board that is designed to be inherently safe. The inherent safety of the circuit board can be implemented, in terms of design—with and without recourse to casting mass—in such a manner that in case of a failure, current and/or voltage are limited so that spark formation is reliably prevented.

The hold-down for the conductor end section that is disposed between the two IDC terminal units normally ensures that the conductor end section is securely held in the IDC terminals of the two IDC terminal units. For this purpose, the hold-down is placed approximately centered between the two IDC terminal units, which are spaced apart from one another. Furthermore, the design is normally arranged so that the hold-down, in the installed state, lies against the conductor end section that is guided between the two IDC terminal units without being attached. In this connection, the method of procedure will generally be that the hold-down lies opposite the IDC terminal plug parts, with regard to the conductor end section that is situated between them. The two assembly plug parts, in contrast, are situated on the same side with regard to the network cable or the conductor end section. The two IDC terminal plug parts, on the other hand, are disposed on the opposite side of the conductor end section.

Because the hold-down is advantageously connected with the housing, assembly of the housing or affixing of the roof to the floor simultaneously ensures that the hold-down assumes the desired and required position in comparison with the conductor end section.

In the end result, an explosion-protected plug-in connector is made available, the two IDC terminal units of which are connected with the conductor end section of the network, taking true redundancy into consideration. In this manner, any electrical device to be connected with the network can be perfectly and safely contacted in the area that is at risk of explosion, using the plug-in connector according to the invention.

In fact, the IDC terminal unit, which is effectively designed double, ensures that undesirable and dangerous spark formation is reliably prevented. Mechanical access is also not possible, because the housing that accommodates and encloses the two IDC terminal units does not permit such manipulations.

All of this is possible, taking a particularly compact and cost-advantageous structure into consideration. This is because all that is required for assembly is to lay the leads of the network cable to be connected, or its conductor end section, into the IDC terminals of the two IDC terminal units. As soon as the housing is now closed, in that the roof enters into a connection with the floor, the assembly plug parts, which are typically provided in the roof, ensure that the individual leads in the related IDC terminal plug part are perfectly contacted. At the same time, the hold-down that submerges between the two IDC terminal units during this process ensures that the conductor end section cannot come loose from the one or the two IDC terminal units. These are the significant advantages.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows the explosion-protected plug-in connector according to the invention in a schematic side view, and

FIG. 2 shows a section through the housing according to FIG. 1.

### DETAILED DESCRIPTION OF THE PREFERRED EMBODIMENT

In the figures, an explosion-protected plug-in connector is shown, in other words a plug-in connector that ensures, in an area at risk of explosion, that a network cable 1 or a network 1 can be connected with an electrical device 2 or a circuit board 2 of the electrical device in question. For this purpose, the plug-in connector is fundamentally equipped with a housing 3 and at least one electrical connector unit 4, 5. At least one conductor end section 6 of the network or network cable 1 engages into this electrical connector unit 4, 5.

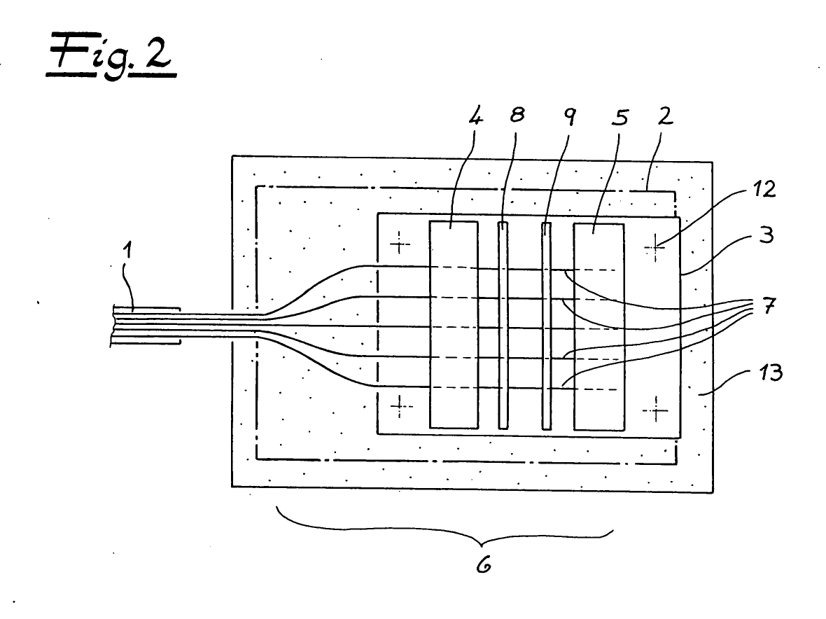

In particular from the top view according to FIG. 2, one can see that the conductor end section 6 of the network or the network cable 1 is composed of a plurality of individual leads 7, which are contacted using the electrical connector unit 4, 5. In the exemplary embodiment, the electrical connector unit 4, 5 is a first IDC terminal unit 4 and a second IDC terminal unit 5. Fundamentally, even more than these two IDC terminal units 4, 5 can also be implemented. The network or network cable 1 can be configured as a round cable, flat strip cable, or the like.

The two IDC terminal units 4, 5 are disposed in the interior of the housing 3, in order to protect them from manipulations from the outside. The conductor end section 6 or its individual leads 7 engage into the two IDC terminal units 4, 5. Furthermore, a hold-down 8, 9 disposed between the two IDC terminal units 4, 5 is provided for the conductor end section 6. Within the scope of the exemplary embodiment, the hold-down 8, 9 is composed of two crosspieces 8, 9 that are connected to a roof 3b of the housing 3.

In fact, the housing 3 is composed of a floor 3a and a roof 3b. The housing 3 is designed in the shape of a sigma (Σ) in cross-section. The floor 3a is predominantly configured in U shape. In contrast, the roof 3b has an L-shaped configuration.

In order to connect the roof 3b with the floor 3a, a stop 10 is provided on the floor 3a. The roof 3b is connected with the stop 10 of the floor 3a in question with its one end, by way of one or more attachment means 11. In fact, two attachment means 11 configured as screws are used at this location and for safety reasons.

The housing 3 itself can be connected with the circuit board 2 using additional attachment means 12, and can define a module 2, 3 in this manner. In fact, the circuit board 2 is enclosed by a casting mass 13 in the exemplary embodiment, which mass of course also encloses the electrical and/or electronic components situated on the circuit board 2, and seals them, together with the circuit board 2. In this manner, the circuit board 2 and consequently also the electrical device equipped with it, as a whole, is designed to be inherently safe or to have the required explosion-protected equipment. Only the two IDC terminal units 4, 5, as the only parts, emerge out of the casting mass 13 that encloses the circuit board 2.

The IDC terminal units 4, 5 in turn are connected with the circuit board 2 or enter into a connection with conductor tracks present on the circuit board 2, with electrical contacts 14. In this connection, the two IDC terminal units 4, 5 stand perpendicular on the circuit board 2 and are disposed essentially parallel to and at the same distance from one another, as shown in FIG. 2. In this manner, the conductor end section 6 of the network or of the network cable 1 engages first into the first IDC terminal unit 4 and afterward as well as finally into the second IDC terminal unit 5, one after the other. In the assembled state, the hold-down 8, 9 submerges or the two crosspieces 8, 9 provided at this location submerge centered between the two IDC terminal units 4, 5.

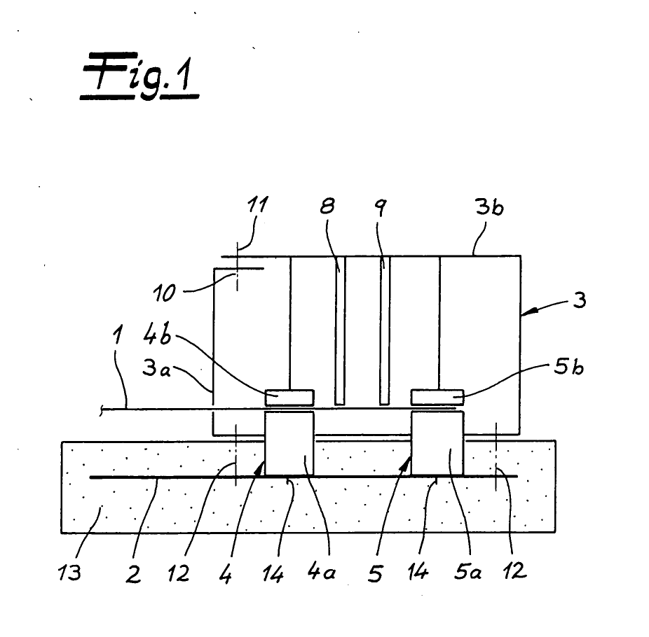

In this connection, the hold-down 8, 9, in the assembled state, lies against the conductor end section 6, which is guided between the two IDC terminal units 4, 5, without being attached. In fact, the two IDC terminal units 4, 5 in the exemplary embodiment are composed of an IDC terminal plug part 4a, 5a and an assembly plug part 4b, 5b. From the sectional drawing according to FIG. 1, one can see that the assembly plug parts 4b, 5b are connected to the housing 3. In fact, the two assembly plug parts 4b, 5b have a connection with the roof 3b of the housing 3.

In this connection, a releasable connection of the assembly plug part 4b, 5b can be implemented in order to use the matching assembly plug part 4b, 5b depending on the IDC terminal plug part 4a, 5a that is being used, or to be able to fall back on it. In any case, the assembly plug part 4b, 5b ensures that when the leads 7 are laid into the related IDC terminal plug part 4a, 5a, the leads 7 are pressed into the related fork-shaped blades of the IDC terminals in such a manner that the insulation is cut through by the fork-shaped blades. The lead 7 enters into the desired electrical connection with the related IDC terminal. This fundamental method of operation is sufficiently known, and reference is made merely as an example, but without restriction, to German Patent Application No. DE 197 44 754 C1, the disclosure of which is herein incorporated by reference.

One can see that the hold-down 8, 9 or the two crosspieces 8, 9 are disposed approximately centered between the two IDC terminal units 4, 5. Furthermore, the hold-down 8, 9 is situated on the top of the conductor end section 6 or lies against this top of the conductor end section 6. The two assembly plug parts 4b, 5b are also situated on the top of the conductor end section 6.

In contrast, the two IDC terminal plug parts 4a, 5a are disposed on the underside of the conductor end section 6. In this manner, the hold-down 8, 9 can impact the conductor end section 6, which is guided between the two IDC terminal units 4, 5 without being attached, so that the conductor end section 6 lies against the hold-down 8, 9 with its top or is actually impacted by the hold-down 8, 9 with a (slight) force in the direction of the IDC terminal plug parts 4a, 5a. In any case, the hold-down 8, 9 ensures that the conductor end section 6 cannot slip out of the IDC terminals or the IDC terminal plug parts 4a, 5a in the installed state, or be torn out in some other way.

The hold-down 8, 9 is positioned as soon as the roof 3b is connected with the floor 3a of the housing 3, falling back on the attachment means 11. At the same time, this connection process of roof 3b and floor 3a of the housing ensures that the leads 7 of the conductor end section 6 are contacted in the IDC terminals of the IDC terminal plug part 4a, 5a. Assembly is therefore very simple and can be carried out without any additional installation tools.

The housing 3 is typically configured to be open on the face side. For production reasons, it has proven itself if the housing 3 is produced in one piece from a sheet-metal part and particularly a punched/bent metal part. In this connection, the hold-down 8, 9 can also be defined in the sheet-metal part within the course of a common punching/bending process. This can be done in that corresponding tabs are produced and bent away in the roof 3b of the housing 3, which define the hold-down 8, 9.

The two IDC terminal units 4, 5 are designed to be redundant, so that the circuit board 2 or an electrical device equipped with the circuit board 2 can communicate with the network 1 or the network cable 1 both by way of the first IDC terminal unit 4 and by way of the second IDC terminal unit 5. In this connection, the contact resistances between the individual leads 7 of the conductor end section 6 and the IDC terminals of the related IDC terminal unit 4, 5 are designed and dimensioned in such a manner that particularly low contact resistances are observed, and on the whole, the risk of spark formation does not exist.

Fundamentally, the contact resistance between the conductor tracks of the circuit board 2 and the IDC terminal units 4, 5 or the leads 7 of the network or network cable 1 can be measured. For this purpose, a monitoring unit can be implemented, which is not explicitly shown and can be a component of a computer connected to the network 1, for example. Because the transition resistance increases, specifically in the event that one IDC terminal unit 4, 5 is not or no longer connected with the related lead 7, for example, in this case the monitoring unit can issue an alarm signal to a remote central location, by way of the network 1.

In this way, a user is informed of possible problems of the explosion-protected plug-in connector, without its fundamental function being impaired in any way. Possible spark formation is also precluded. Nevertheless, the monitoring unit allows reliable monitoring and reporting of damage to or in the area of the explosion-protected plug-in connector according to the invention, which can be monitored from a remote location.

A telephone, specifically, in particular, a VoIP telephone, which is equipped with a circuit board 2 and the plug-in connector described above, is also an object of the invention. In this connection, the circuit board 2 can carry the electrical and electronic components that are necessary for usual operation of a telephone. The VoIP telephone in question is suitable for telephoning via the network or computer network 1, whereby telephony takes place according to the Internet standard. In this connection, data typical for telephones, in other words voice and control data, are transmitted by way of the network 1. At the subscriber locations, computers, telephones specialized for IP telephony, and traditional telephones connected by way of special adapters can produce the connection. This is fundamentally known, and reference is made to International Application No. WO 2006/045810 A1as an example, the disclosure of which is herein incorporated by reference,

Accordingly, while only a few embodiments of the present invention have been shown and described, it is obvious that many changes and modifications may be made thereunto without departing from the spirit and scope of the invention.

What is claimed is:

1. An explosion-protected plug-in connector for coupling of a VoIP telephone with a network, comprising:
at least one housing;
at least one first electrical connector unit disposed in the housing and being configured as an IDC terminal unit; and
a second electrical connector unit disposed in the housing, said second electrical connector unit being configured as an IDC terminal unit,
wherein a conductor end section of the network engages into the two IDC terminal units, and wherein a hold-down disposed between the two IDC terminal units is provided for the conductor end section.

2. The plug-in connector according to claim 1, wherein the two IDC terminal units are disposed essentially parallel to one another.

3. The plug-in connector according to claim 1, wherein the conductor end section engages into the first IDC terminal unit and then into the second IDC terminal unit, one after the other.

4. The plug-in connector according to claim 1, wherein the hold-down is disposed approximately centered between the two IDC terminal units.

5. The plug-in connector according to claim 4, wherein the hold-down is connected to the housing.

6. The plug-in connector according to claim 1, wherein the hold-down, in an installed state, lies against the conductor end section that is guided between the two IDC terminal units without being attached to the conductor end section.

7. The plug-in connector according to claim 1, wherein the housing is configured in the form of a sigma, in cross-section, with U-shaped floor and an L-shaped roof.

8. The plug-in connector according to claim 7, the roof is connected with the floor using a stop.

9. The plug-in connector according to claim 7, further comprising at least two attachment means for connecting the roof and the floor.

10. The plug-in connector according to claim 1, wherein the housing is configured to be open on a face side.

11. The plug-in connector according to claim 1, wherein the housing is produced in one piece from a sheet-metal part.

12. The plug-in connector according to claim 1, wherein the two IDC terminal units are each equipped with an IDC terminal plug part and an assembly plug part.

13. The plug-in connector according to claim 12, wherein each assembly plug part is provided on a roof of the housing.

14. The plug-in connector according to claim 1, wherein the two IDC terminal units are the only parts that emerge from a casting mass that encloses the circuit board.

15. A VoIP telephone, comprising:
a circuit board connected with a network using an explosion-protected plug-in connector, the connector comprising:
at least one housing;
at least one first electrical connector unit disposed in the housing and being configured as an IDC terminal unit; and
a second electrical connector unit disposed in the housing, said second electrical connector unit being configured as an IDC terminal unit,
wherein a conductor end section of the network engages into the two IDC terminal units, and wherein a hold-down disposed between the two IDC terminal units is provided for the conductor end section.
